(19) United States
(12) Patent Application Publication
(10) Pub. No.: US 2026/0175667 A1
(43) Pub. Date: Jun. 25, 2026

(54) VEHICLE BODY STRUCTURE

(71) Applicant: HONDA MOTOR CO., LTD., Tokyo (JP)

(72) Inventors: Yuki MURAMATSU, Tokyo (JP); Yuki MATSUSHIMA, Tokyo (JP)

(21) Appl. No.: 19/407,194

(22) Filed: Dec. 3, 2025

(30) Foreign Application Priority Data
Dec. 25, 2024 (JP) 2024-229483

(51) Int. Cl. B60K 1/04; B62D 25/20

(52) U.S. Cl. CPC B60K 1/04; B62D 25/20; B60K 2001/0438

(57) ABSTRACT

A vehicle body structure includes a vehicle body frame, and a battery case that accommodates a battery and is attached to the vehicle body frame. The battery case includes an accommodation part that accommodates the battery and a battery cover that covers the accommodation part from an upper side. A seat support structure that supports seats of the vehicle is provided on an upper surface of the battery cover. A cover reinforcement frame is provided on the lower surface of the battery cover. At least a part of the cover reinforcement frame is arranged at a position overlapping with the seat support structure in an up-down direction.

### CROSS-REFERENCE TO RELATED APPLICATION

The present application claims the benefit of priority to Japanese Patent Application No. 2024-229483 filed on December 25 2024, the disclosures of all of which are hereby incorporated by reference in their entireties.

### TECHNICAL FIELD

The present invention relates to a vehicle body structure.

### BACKGROUND

In recent years, research and development has been conducted on weight reduction to contribute to energy efficiency, with the aim of enabling more people to easily access affordable, reliable, sustainable, and advanced energy.

Conventionally, a vehicle body structure is known in which a front-seat front cross member and a front-seat rear cross member that support front seats are provided between right and left door sills, and an upper cover plate of a battery pack is connected from below the front-seat front cross member and the front-seat rear cross member (for example, Chinese Patent No. 110316259).

### SUMMARY

In the present technology relating to weight reduction, there is an object to suppress the weight of the cross members while enabling the seats to be firmly supported.

However, the conventional technology has a structure in which the seats are supported by the cross members provided above the cover plate. Therefore, the cross members need to be formed firmly so as to withstand input from the seats, which leads to an increase in weight of the cross members. Further, there is a problem if a shape of the cross members is increased in size in order to form the cross members firmly, occupant spaces are hindered, so that there is room for further improvement.

The present invention is to provide a vehicle body structure capable of suppressing an increase in weight of cross members and firmly supporting a seat without hindering the occupant spaces. This contributes to energy efficiency.

To solve the problem described above, a vehicle body structure of the present invention includes a vehicle body structure including: a vehicle body frame; and a battery case that accommodates a battery and is attached to the vehicle body frame. The battery case includes: an accommodation part that accommodates the battery; and a battery cover that covers the accommodation part from an upper side. A seat support structure to support seats of a vehicle is provided on an upper surface of the battery cover. A cover reinforcement frame is provided on a lower surface of the battery cover. At least a part of the cover reinforcement frame is arranged at a position overlapping with the seat support structure in an up-down direction.

According to the present invention, a vehicle body structure is provided that can suppress an increase in weight of cross members and can firmly support seats without hindering occupant spaces.

### BRIEF DESCRIPTION OF THE DRAWINGS

FIG. 1 is an exploded perspective view of a vehicle, showing a vehicle body structure according to an embodiment of the present invention;

FIG. 2 is a perspective view showing an upper surface of a battery cover in the vehicle body structure of the embodiment;

FIG. 3 is a perspective view illustrating a configuration of a lower surface of the battery cover;

FIG. 4 is a cross-sectional view taken along a line IV-IV in FIG. 2, illustrating a configuration of main parts; and

FIG. 5 is a cross-sectional view taken along a line V-V in FIG. 2, illustrating the configuration of the main parts.

### DETAILED DESCRIPTION

Next, a description is given of an embodiment of the present invention with reference to accompanying drawings as appropriate. In the description, the same members are denoted by the same reference numerals, and the same descriptions are omitted. Further, directions are indicated based on front, rear, right, left, up, and down directions as viewed from a driver of a vehicle. Note that a vehicle width direction is the same as a right-left direction.

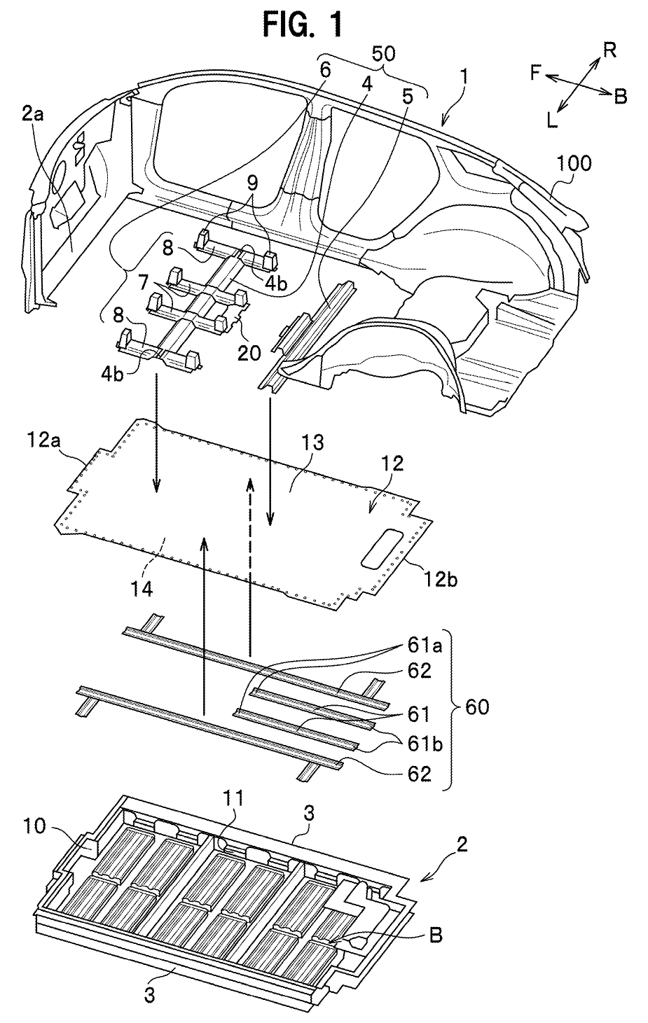

FIG. 1 shows a vehicle body structure used in a vehicle 1 of the embodiment.

The vehicle 1 includes a vehicle body frame 2 mainly constituting a lower part, a body 100 constituting an upper part and forming a vehicle cabin, and a battery case 10 that accommodates a battery B and is attached to the vehicle body frame 2.

Among these members, the vehicle body frame 2 includes a pair of side sills 3 respectively extending in a vehicle front-back direction at both right and left sides of a dash panel 2a arranged in a front part of the vehicle cabin. The battery case 10 is attached to the side sills 3.

The battery case 10 includes a recessed accommodation part 11 that accommodates a battery B, and a flat battery cover 12 that covers the accommodation part 11 from an upper side. In the present embodiment, a front edge 12a of the battery cover 12 is connected to a lower edge of the dash panel 2a. The battery cover 12 constitutes a floor panel of a vehicle body.

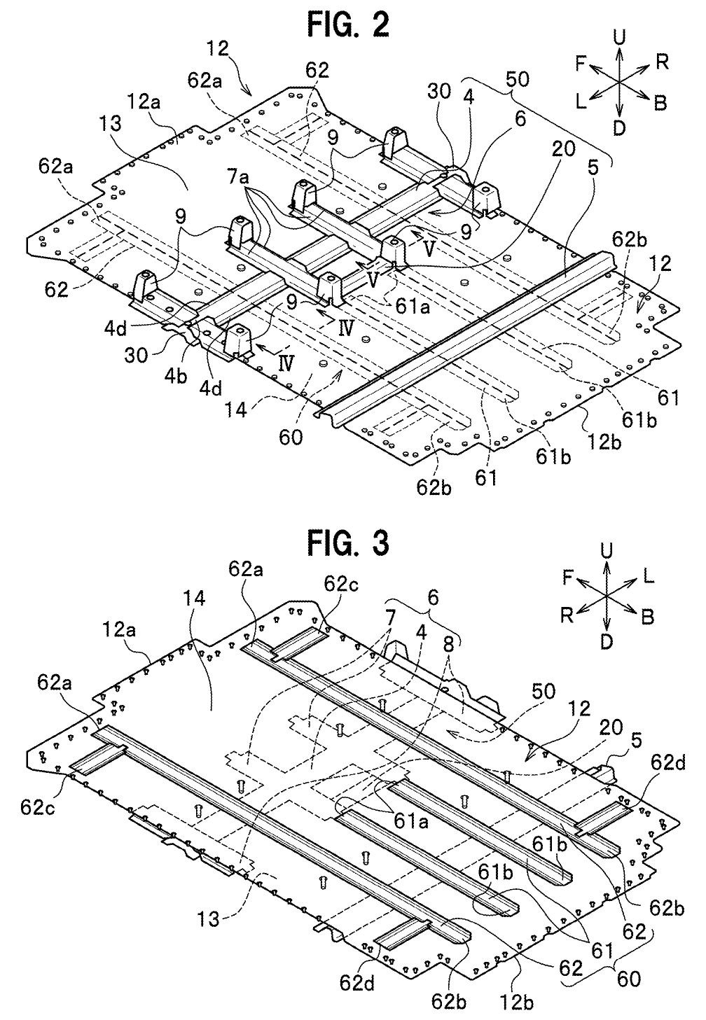

As shown in FIG. 2, a seat support structure 50 that supports a seat 40 (see FIG. 5) of the vehicle 1 is arranged on an upper surface 13 of the battery cover 12.

The seat support structure 50 of the embodiment includes a cross member 4 extending in the vehicle width direction at an intermediate position in the vehicle front-back direction, a pair of inner support frames 7 provided around the center of the cross member 4 in the vehicle width direction, and a pair of outer support frames 8 respectively provided around right and left side edges of the battery cover 12 in the vehicle width direction.

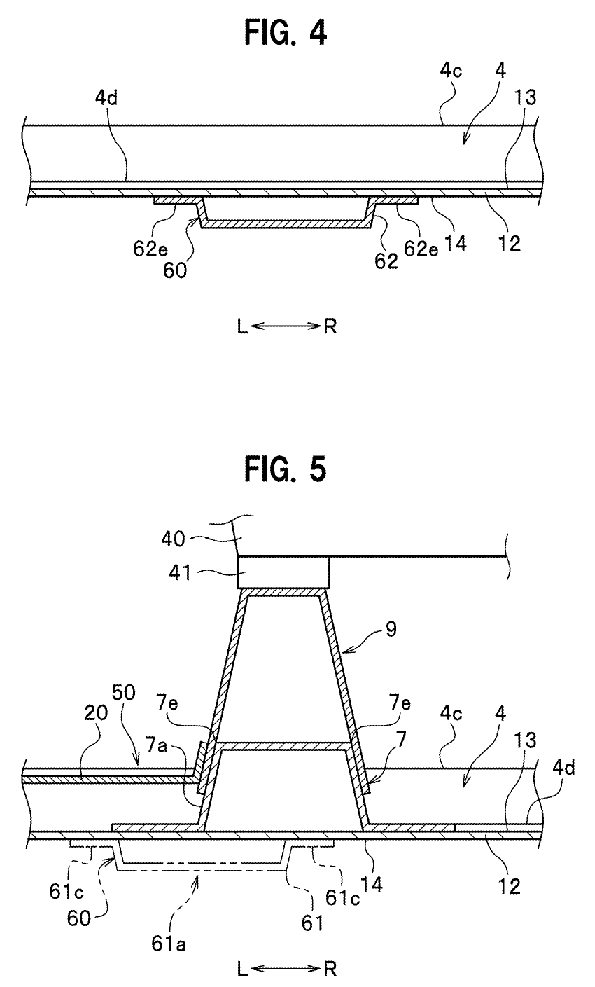

Among these members, the cross member 4 has a hat-shaped cross section, and flanges 4d formed on both sides of the cross member 4 are connected on the upper surface 13 of the battery cover 12. Further, the cross member 4 has cross member ridges 4c extending in the vehicle width direction between the upper surface 4a and sidewalls (see FIG. 4). Each cross member ridge 4c is continuously formed linearly in a range from a side end 4b on the left side to a side end 4b on the right side in the vehicle width direction without being bent in an up-down direction.

Further, in the embodiment, as shown in FIG. 2, a seat support frame 6 connected to the cross member 4 so as to intersect with each other is arranged on the upper surface 13 of the battery cover 12.

The seat support frame 6 includes the pair of inner support frames 7 provided around the center in the vehicle width direction, and the pair of outer support frames 8 provided around the right and left side edges of the battery cover 12 in the vehicle width direction.

The inner support frame 7 and the outer support frame 8 on the right side of the vehicle are paired to support the front-right seat 40. Further, the inner support frame 7 and the outer support frame 8 on the left side of the vehicle are paired as another set to support the front-left seat 40.

A pair of right and left seat slide rails 41 are provided at a lower portion of each seat 40, so that a seat surface of the seat is slidable in the vehicle front-back direction. Further, an entire length of the inner support frames 7 and the outer support frames 8 of the embodiment is set to be substantially the same as an entire length of the seat slide rails 41.

As shown in FIG. 2, the inner support frames 7 are provided in a pair side by side at the center in the vehicle width direction. The inner support frames 7 intersect with the cross member 4 and are formed continuously in the vehicle front-back direction. The inner support frames 7 are formed to have a hat-shaped cross-sectional shape that opens downward, and are formed to have a larger vertical dimension than the cross member 4. Further, the inner support frames 7 have flanges 7a formed over an entire length on the right and left sides in the vehicle width direction.

The inner support frames 7 are arranged so as to straddle the cross member 4 from an upper side, and the flanges 7a are connected on the upper surface 13 of the battery cover 12 so that the inner support frames 7 are fixed on the upper surface 13 of the battery cover 12, together with the cross member 4.

Further, an intermediate part of each inner support frame 7 in the front-back direction has a recessed part on the lower surface side engaged with the cross member 4 from an upper side, and flanges on the right and left sides are joined to the upper surface and the front and rear side walls of the cross member 4.

Thus, the inner support frames 7 are orthogonal to the cross member 4, and frame ridges 7e of the inner support frames 7 and the cross member ridges 4c of the cross member 4 are separated in the up-down direction (see FIG. 5) and intersect with each other in a top view.

The inner support frames 7 extend substantially the same length in the vehicle front-back direction with respect to the cross member 4, and are fixed on the upper surface 13 of the battery cover 12, respectively.

Further, seat attachment brackets 9 are respectively provided at the front end and the rear end of each inner support frame 7. The seat attachment brackets 9 each are attached to a front end and a rear end of a seat slide rail 41, to support the seat 40 of the vehicle 1 from a lower side, respectively.

Further, as shown in FIG. 2, the front ends of the inner support frames 7 are spaced apart from each other, without extending forward to the dash panel 2a. Thus, the front ends of the inner support frames 7 are not connected to the dash panel 2a.

Further, the vehicle body structure of the embodiment includes a rear cross member 5 as one member of the seat support structure 50. The rear cross member 5 is provided on the upper surface 13 of the battery cover 12 in parallel with the cross member 4, having a predetermined distance in the vehicle front-back direction.

Rear ends of the inner support frames 7 are spaced apart from each other, without extending to the rear cross member 5. Thus, the rear ends are not connected to the rear cross member 5.

Further, the vehicle body structure of the embodiment includes a reinforcement member 20 as one member of the seat support structure 50. The reinforcement member 20 has a hat-shaped cross-sectional shape that opens downward, and is provided on the upper surface 13 of the battery cover 12 so as to extend in the vehicle width direction at an intermediate position between the cross member 4 and the rear cross member 5. The reinforcement member 20 connects the rear ends of the pair of inner support frames 7 adjacent to each other in the vehicle width direction.

Further, flanges of the reinforcement member 20 at the front side and the rear side of the vehicle are connected on the upper surface 13 of the battery cover 12 to fix the reinforcement member 20. The reinforcement member 20 connects the rear ends of the pair of inner support frames 7 arranged adjacent to each other. Thus, the reinforcement member 20 has a square shape in a top view together with the cross member 4 and the pair of inner support frames 7.

Thus, the inner support frames 7 supporting the right and left seats 40 are further connected firmly.

The load input from one seat 40 to the seat support frame 6 is transmitted to the other inner support frame 7 of the other seat 40 arranged adjacent to the one seat 40 via one inner support frame 7 and the reinforcement member 20 or the cross member 4, and is dispersed in the vehicle width direction.

Further, the outer support frames 8 provided on the outer side of the inner support frames 7 in the vehicle width direction are arranged along the inner side of the side sills 3.

As shown in FIG. 1, the outer support frames 8 each have two frame portions divided in the front-back direction. The outer support frames 8 of the embodiment each have a hat-shaped cross-sectional shape that is open downward. The two frame portions, having the same length, are arranged continuously along the front-back direction, and are joined on the upper surface 13 of the battery cover 12.

In the outer support frame 8 of the embodiment, the flange portions facing each other are joined on an upper surface of the cross member 4 in the up-down direction at a divided portion in the middle in the front-back direction. The seat attachment brackets 9 are provided at the front end and the rear end of each outer support frame 8.

The front end and the rear end of the seat slide rail 41 are attached to the seat attachment brackets 9 from an upper side. Thus, the outer support frames 8 support the seats 40 from a lower side, respectively.

Further, as shown in FIG. 1, the front ends of the outer support frames 8 are spaced apart from the dash panel 2a shown in FIG. 1, without extending forward. Thus, the front ends are not connected to the dash panel 2a. Still further, the rear ends of the outer support frames 8 are spaced apart from the rear cross member 5 without extending rearward. Thus, the rear ends are not connected to the rear cross member 5.

Further, in the vehicle body structure of the embodiment, the right and left side ends 4b of the cross member 4 are connected to the side sills 3 respectively via a pair of right and left extension members 30 that are provided in advance so as to protrude from the side sills 3.

Accordingly, the load applied to the inner support frames 7 and the outer support frames 8 supporting the seats 40 is transmitted to the right and left sides of the vehicle body frame 2 via the cross member 4 and the extension members 30, respectively. Thus, the load is dispersed.

As shown in FIG. 3, a cover reinforcement frame 60 is provided on a lower surface 14 of the battery cover 12. At least a part of the cover reinforcement frame 60 is arranged at a position overlapping with the seat support structure 50 in the up-down direction.

In the vehicle body structure of the embodiment, the cover reinforcement frame 60 includes the pair of inner reinforcement frames 61 and pair of outer reinforcement frames 62.

Further, the inner reinforcement frames 61 (see FIG. 5) and outer reinforcement frames 62 (see FIG. 4) of the cover reinforcement frame 60 each have a hat-shaped cross-sectional shape that opens upward and extend in the front-back direction of the vehicle 1 as shown in FIG. 3.

As shown in FIG. 4, each outer reinforcement frame 62 has flanges 62e on the right and left sides in the vehicle width direction over an entire length. The flanges 62e are connected to be fixed to the lower surface 14 of the battery cover 12.

The outer reinforcement frame 62 forms a closed cross section having a square cross-sectional shape together with the battery cover 12. In the embodiment, a dimension in the right-left width direction of the closed cross section formed by the outer reinforcement frame 62 and the battery cover 12 is set to be larger than a dimension thereof in the up-down direction.

As shown in FIG. 5, each inner reinforcement frame 61 has flanges 61c on the right and left sides in the vehicle width direction over the entire length. The flanges 61c are connected to be fixed on the lower surface 14 of the battery cover 12. The inner reinforcement frame 61 forms a closed cross section having a square cross-sectional shape together with the battery cover 12.

In the embodiment, the closed cross section formed by the inner reinforcement frame 61 and the battery cover 12 is set such that the dimension in the right-left width direction is larger than the dimension in the up-down direction.

Also, as shown in FIG. 5, the inner reinforcement frame 61 is formed such that the dimension in the right-left width direction is equal to the dimension in the right-left width direction of the inner support frame 7, and at least a part of the inner reinforcement frame 61 intersects with the inner support frame 7 in the vehicle width direction.

Further, the vertical dimensions of the inner reinforcement frame 61 and outer reinforcement frame 62 of the embodiment are set to be smaller than the vertical dimension of the cross member 4. The vertical dimension of the inner reinforcement frame 61 is set to be equal to the vertical dimension of the outer reinforcement frame 62.

As shown in FIG. 5, a front end 61a of each inner reinforcement frame 61 is arranged at a position overlapping with the rear end of each inner support frame 7 and a side end of the reinforcement member 20, which constitute the seat support structure 50, respectively.

Further, as shown in FIG. 3, rear ends 61b of the inner reinforcement frames 61 extend toward a rear edge 12b of the battery cover 12 to be aligned with positions of rear ends 62b of the outer reinforcement frames 62 in the vehicle front-back direction.

Further, in the vehicle body structure of the embodiment, as shown in FIG. 3, front ends 62a of the outer reinforcement frames 62 in the cover reinforcement frame 60 extend to the front edge 12a of the battery cover 12. The outer reinforcement frames 62 are provided from the front edge 12a to the rear edge 12b of the battery cover 12.

Also, outer edges of the front ends 62a are connected to front ends 62c extending outward in the vehicle width direction, respectively.

Further, outer edges of the rear ends 62b of the outer reinforcement frames 62 are connected to rear ends 62d extending outward in the vehicle width direction, respectively.

This improves the rigidity of the edges, namely, the front edge 12a and the rear edge 12b of the battery cover 12.

As shown in FIG. 3, each outer reinforcement frame 62 of the cover reinforcement frame 60 extends in the front-rear direction, and intermediate positions thereof in the front-rear direction intersect with the cross member 4 (see FIG. 2) of the seat support structure 50 with the battery cover 12 interposed therebetween in the up-down direction.

Thus, the cross member 4 extending in the vehicle width direction is firmly supported from a lower side by the outer reinforcement frames 62 extending in the front-rear direction, thereby improving attachment rigidity of the seats 40 attached to the cross member 4.

As shown in FIG. 2, the cross member 4 of the embodiment intersects with the intermediate positions of the inner support frames 7 and the outer support frames 8 in the front-rear direction, and is supported from a lower side by the outer reinforcement frames 62 and the inner reinforcement frames 61 extending with respect to the cross member 4 in the front-back direction.

Thus, the load to the seats 40 applied from the inner support frames 7 and the outer support frames 8 can be efficiently received and dispersed over a wide range of the battery cover 12 in the front-rear direction to support the seats 40.

Further, the upper surface 13 of the battery cover 12 has the rear cross member 5 that supports rear seats (not shown) of the plurality of seats 40. The inner reinforcement frames 61 and outer reinforcement frames 62 of the cover reinforcement frame 60 intersect with the rear cross member 5, respectively.

The rear ends 61b of the inner reinforcement frames 61 and the rear ends 62b of the outer reinforcement frames 62 further extend from the rear cross member 5 toward the rear edge 12b of the battery cover 12. Accordingly, in the embodiment, the front and rear seats 40 can be supported by the same inner reinforcement frames 61 and outer reinforcement frames 62 which extend in the front-rear direction. Therefore, the number of components can be decreased, and an increase in weight can be further suppressed.

In the vehicle body structure of the embodiment configured as described above, as shown in FIG. 1, the battery case 10 is attached to the vehicle body frame 2 constituting the lower part of the vehicle 1.

The battery case 10 is attached to the battery cover 12 so as to cover an upper surface of the accommodation part 11 in which the battery B is accommodated. The cover reinforcement frame 60 is joined in advance on the lower surface 14 of the battery cover 12.

In the embodiment, the vertical dimension of the inner reinforcement frames 61 and the outer reinforcement frames 62 constituting the cover reinforcement frame 60 is set to be smaller than the vertical dimension of the cross member 4. Therefore, a gap can be formed with respect to an upper surface of the battery B accommodated in the battery case 10.

A periphery of the battery cover 12 is fixed to a periphery of the accommodation part 11 with a plurality of fixing members such as screws, to close the accommodation part 11.

In addition, in the vehicle body frame 2, the extension members 30 as shown in FIG. 2 are provided in advance so as to protrude inward at intermediate positions in the vehicle front-rear direction of the side sills 3 on both right and left sides. The cross member 4 of the seat support structure 50 is fixed to join on the upper surface 13 of the battery cover 12. The right and left ends of the cross member 4 are joined to the extension members 30 from an upper side, and the cross member 4 is fixed to intermediate parts of the side sills 3 in the front-rear direction.

Further, the rear cross member 5 of the seat support structure 50 is fixed to join on the upper surface 13 of the battery cover 12, having a predetermined distance from the cross member 4 in the vehicle front-rear direction.

As shown in FIG. 2, the front ends 61a of the inner reinforcement frames 61 in the cover reinforcement frame 60 mounted on the lower surface 14 of the battery cover 12 are arranged at positions overlapping, in the up-down direction, with the rear ends of the inner support frames 7 extending rearward from an intermediate position in the vehicle width direction of the cross member 4 extending in the vehicle width direction, and the rear ends 61b extend rearward the vehicle body.

As shown in FIG. 5, the inner support frame 7 has a substantially hat-shaped cross section and forms a closed cross section with the upper surface 13 of the battery cover 12. Further, the inner reinforcement frame 61 has a hat-shaped cross section and forms a closed cross section with the lower surface 14 of the battery cover 12. A part of the inner reinforcement frame 61 forming the closed cross section overlaps to intersect with the closed cross section formed by the inner support frame 7 in the up-down direction, having the battery cover 12 interposed therebetween.

Further, the cross member 4 having a hat-shaped cross section forms a closed cross section with the upper surface 13 of the battery cover 12. The closed cross section is continuously provided linearly in a range from the left side end 4b to the right side end 4b in the vehicle width direction, without being bent in the up-down direction.

Also, as shown in FIG. 4, the outer reinforcement frame 62 having a hat-shaped cross section in the cover reinforcement frame 60 has a closed cross section formed with the lower surface 14 of the battery cover 12. The closed cross section is provided to intersect in the up-down direction with the closed cross section formed by the cross member 4.

As shown in FIG. 3, the outer reinforcement frames 62 are provided from the front edge 12a of the battery cover 12 to the rear edge 12b of the battery cover 12.

In this way, the battery cover 12 is sandwiched between the seat support structure 50 and the cover reinforcement frame 60 in the up-down direction to improve rigidity.

Thus, the cross member 4 extending in the vehicle width direction is firmly supported from a lower side by the inner reinforcement frames 61 and the outer reinforcement frames 62 extending in the front-rear direction. Thus, a load applied from the seats is dispersed over a wide range in the front-rear direction of the battery cover 12 to support the seats.

Therefore, the seat support structure 50 can effectively receive the load from the seats to suppress an increase in weight of the seat support structure 50, so as to lighten the vehicle body.

The cover reinforcement frame 60 is arranged on the lower surface of the battery cover 12 so as not to obstruct vehicle interior spaces.

Further, in the embodiment, the vertical dimensions of the inner reinforcement frames 61 and outer reinforcement frames 62 are set to be smaller than the vertical dimension of the cross member 4. Therefore, it is possible to easily prevent interference with the battery B accommodated in the accommodation part 11 formed in a concave shape of the battery case 10.

Accordingly, the vehicle 1 to which the present invention is applied can exhibit practically advantageous effects to obtain desired seat support rigidity, without inhibiting the occupant spaces while suppressing an increase in vehicle body weight.

As described above, the vehicle body structure of the present invention includes the vehicle body frame 2 and the battery case 10 that accommodates the battery B and is attached to the vehicle body frame 2, as shown in FIG. 1. The battery case 10 includes the accommodation part 11 that accommodates the battery B, and the battery cover 12 that covers the accommodation part 11 from an upper side. As shown in FIG. 5, the seat support structure 50 that supports the seats 40 of the vehicle 1 is provided on the upper surface 13 of the battery cover 12.

Further, the cover reinforcement frame 60 is provided on the lower surface 14 of the battery cover 12. As shown in FIG. 3, at least a part of the cover reinforcement frame 60 is arranged at a position overlapping with the seat support structure 50 in the up-down direction.

The vehicle body structure of the present invention configured as described above can provide a vehicle body structure capable of suppressing an increase in weight of the seat support structure 50 and firmly supporting the seats 40 without inhibiting the occupant spaces.

Specifically, the cover reinforcement frame 60 is provided on the lower surface 14 of the battery cover 12, and at least a part of the cover reinforcement frame 60 is arranged at a position overlapping with the seat support structure 50 in the up-down direction.

Thus, the battery cover 12 has a structure, being sandwiched between the seat support structure 50 and the cover reinforcement frame 60 in the up-down direction, so that the battery cover 12 has improved rigidity.

Further, the seat support structure 50 is supported from a lower side by the cover reinforcement frame 60, arranged to be overlapped with the seat support structure 50. Therefore, the seat support structure 50 can effectively receive the load from the seats 40, which suppresses an increase in weight of the seat support structure 50 to reduce the weight of the vehicle body.

Then, the cover reinforcement frame 60 is disposed on the lower surface of the battery cover 12 so as not to obstruct the vehicle interior spaces.

Thus, the vehicle 1 to which the present invention is applied can obtain desired seat support rigidity while suppressing an increase in weight of the vehicle body, without inhibiting the occupant spaces.

Further, as shown in FIG. 3, the cover reinforcement frame 60 extends in the front-rear direction, and is arranged at a position where the front ends 61a of the inner reinforcement frames 61 overlap with the rear ends of the inner support frames 7 extending from the seat support structure 50, and the inner reinforcement frames 61 are formed to extend rearward the vehicle body.

Thus, the cover reinforcement frame 60 supports the seat support structure 50 from a lower side and reinforces the battery cover 12 over a wide range to a rear part so as to increase rigidity.

Further, the seat support structure 50 includes the cross member 4 extending in the vehicle width direction. At least a part of the cover reinforcement frame 60 extends in the front-rear direction to intersect with the cross member 4.

Thus, the cross member 4 extending in the vehicle width direction is firmly supported from a lower side by the outer reinforcement frames 62 extending in the front-rear direction and can disperse the load over a wide range in the front-rear direction of the battery cover 12 to support the seats 40. Therefore, support rigidity of the seats 40 attached to the cross member 4 can be further improved.

Further, the rear cross member 5 that supports rear seats (not shown) of the seats 40 is provided on the upper surface 13 of the battery cover 12. Then, the cover reinforcement frame 60 intersects with the rear cross member 5.

In this way, the cover reinforcement frame 60 intersects with the seat support structure 50 from the lower surface 14 of the battery cover 12 to support from a lower side. Therefore, the load of the rear seats can be efficiently received and can be dispersed over a wide range of the battery cover 12 to support the seats 40.

Therefore, an increase in weight of the rear cross member 5 is suppressed and the rear seats can be firmly supported without inhibiting the occupant spaces.

The cover reinforcement frame 60 is formed to have a hat-shaped cross-section that opens upward. The cover reinforcement frame 60 is connected on the lower surface 14 of the battery cover 12 to form a closed cross section.

Thus, the closed cross section is formed so that rigidity of the battery cover 12 can be effectively improved.

Further, in the embodiment, dimensions in the up-down direction of the inner reinforcement frames 61 and outer reinforcement frames 62 are set to be smaller than the dimension in the up-down direction of the cross member 4. Therefore, the rigidity of the battery cover 12 can be effectively improved without interfering with the battery B accommodated in the battery case 10.

At least a part of the cover reinforcement frame 60 is provided from the front edge 12a to the rear edge 12b of the battery cover 12.

Therefore, rigidity can be improved over a wide range in the front-rear direction of the battery cover 12.

The present invention is not limited to the embodiment described above, and various modifications can be made. The above embodiment is an example for easy understanding of the present invention, and the present invention is not necessarily limited to that having all the configurations described above. In addition, a part of the configuration of a certain embodiment can be replaced with the configuration of another embodiment, and the configuration of another embodiment can be added to the configuration of the certain embodiment. Further, a part of the configuration of each embodiment can be deleted, or another configuration can be added or replaced. A possible modification of the above embodiment is, for example, as follows.

In the vehicle body structure of the embodiment, the cover reinforcement frame 60 is configured to include the pair of inner reinforcement frames 61 and pair of outer reinforcement frames 62. However, the present invention is not particularly limited to the configuration above. That is, in the vehicle body structure of the present invention, at least a part of the cover reinforcement frame 60 may be arranged at a position overlapping with the seat support structure 50 in the up-down direction. Further, a shape, a quantity, and a material of the cover reinforcement frame 60 provided on the lower surface 14 of the battery cover 12 are not particularly limited.

What is claimed is:

1. A vehicle body structure comprising:
a vehicle body frame; and
a battery case that accommodates a battery and is attached to the vehicle body frame, wherein,
the battery case includes:
an accommodation part that accommodates the battery; and
a battery cover that covers the accommodation part from an upper side,
the battery cover having an upper surface on which a seat support structure to support seats of a vehicle is provided,
the battery cover having a lower surface on which a cover reinforcement frame is provided, and
at least a part of the cover reinforcement frame is arranged at a position overlapping with the seat support structure in an up-down direction.

2. The vehicle body structure according to claim 1, wherein the cover reinforcement frame extends in a front-rear direction, a front end of the cover reinforcement frame is arranged at a position overlapping with rear end of the seat support structure and is formed to extend rearward the vehicle body.

3. The vehicle body structure according to claim 1, wherein the seat support structure includes a cross member extending in a vehicle width direction, and
at least a part of the cover reinforcement frame extends in a front-back direction to intersect with the cross member.

4. The vehicle body structure according to claim 1, wherein a rear cross member that supports rear seats of the seats is provided on the upper surface of the battery cover, and
the cover reinforcement frame intersects with the rear cross member.

5. The vehicle body structure according to claim 1, wherein the cover reinforcement frame is formed to have a hat shaped cross section that opens upward to be connected on the battery cover to form a closed cross section.

6. The vehicle body structure according to claim 1, wherein at least a part of the cover reinforcement frame is provided from a front edge of the battery cover to a rear edge of the battery cover.
